(19) United States
(12) Patent Application Publication
(10) Pub. No.: US 2007/0053536 A1
(43) Pub. Date: Mar. 8, 2007

(54) Hearing aid system

(76) Inventor: Patrik Westerkull, Gothenburg (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/210,582

(22) Filed: Aug. 24, 2005

(51) Int. Cl. H04R 25/00

(52) U.S. Cl. 381/326

(57) ABSTRACT

A bone conduction hearing aid system for generating bone conduction vibrations is disclosed. The bone conduction hearing aid system has an external hearing aid unit with a vibrator and a skin contact pressure plate. The skin contact pressure plate is placed on an outside of the external hearing aid unit and the skin contact pressure plate is magnetically attached to an implanted unit anchored to the skull under the skin. The vibrator transforms an electrical signal into mechanical vibrations and the skin contact pressure plate allows transmission of the vibrations from the vibrator to the implanted unit when the external hearing aid unit is magnetically fixed to the implanted unit.

### TECHNICAL FIELD

The present invention relates to a hearing aid system for providing bone conduction hearing.

### BACKGROUND OF THE INVENTION

Bone conduction is the principle of transmitting vibrations via the skull bone to the inner ear, i.e. the cochlea. Several different types of bone conduction hearing aids are available. However, they all include significant drawbacks for the patient, as described below.

The traditional bone conductor consists of a hearing aid with a vibrator that is pressed against the head behind the ear by a spring arrangement extending from the other side of the head. The steel spring arrangement is sometimes built into an eyeglass frame. The vibrations are then transmitted through the skin and the skull bone into the cochlea. For the traditional bone conductors with a spring arrangement around the head the constant pressure against the skull bone often causes headaches and the patients often complain about the poor esthetics.

Another type of bone conductor, which is sometimes called a direct bone conductor, includes a vibrator, which is directly and firmly connected to an anchoring component that is anchored to the skull bone and through which the vibrations are directly transmitted from the vibrator to the skull bone. The vibrations do not pass through the skin on its way from the vibrator to the skull bone. If this type of bone conductor is designed with a permanent skin penetration patients often have problems with skin infections. If this type of bone conductor is instead designed with a fully implanted vibrator there is a significant energy loss when transmitting the energy with an inductive link through the skin and another drawback is that the vibrator can not easily be repaired if it breaks down.

Another type of bone conductor that has sometimes also been called a direct bone conductor is a type where the vibrator is not integrated into one unit but divided into two separate units so that one part of the vibrator is placed in an external device outside the skin and one part is implanted under the skin. In this arrangement the electromagnetic signal from the external part of the vibrator is passing through the skin to the implanted part of the vibrator anchored to the skull bone. For this type of bone conductor the efficiency of the vibrator is significantly reduced since the electromagnetic signal has to pass through the skin that is quite thick. If the skin would be surgically prepared so that it becomes very thin this would lead to skin necrosis due to poor blood supply in the compressed skin so this type of device does not work well. There is a need for a more effective hearing aid system that is reliable and does not have the drawbacks discussed above.

### SUMMARY OF THE INVENTION

The present invention provides an effective solution to the above-outlined problems with bone conduction hearing aids. More particularly, the bone conduction hearing aid system of the present invention has an external hearing aid unit with an integrated vibrator and a skin contact pressure plate. The skin contact pressure plate is placed on the outside of the external hearing aid unit so that it can exert a pressure against the skin. The skin contact pressure plate includes a magnetic material so that it can attach magnetically to an implanted unit under the skin. Preferably, a magnetic material should include a material that has magnetic properties. For example, the material may be a permanent magnet or a ferromagnetic material. The implanted part is anchored in the skull. With an implanted unit may here be meant a unit that is fully implanted under an intact skin layer. With an intact skin layer is meant a skin layer where there is no permanent skin penetrating component via which it is possible to make mechanical contact with the implanted unit. The vibrator of the present invention is, preferably, integrated in one unit so that it can be enclosed by a housing of the external hearing aid unit. The vibrator can transform an electrical signal into mechanical vibrations. The skin contact pressure plate allows transmission of the vibrations from the vibrator to the implanted unit when the external hearing aid unit is magnetically attached to the implanted unit.

The vibrator of the present invention may, just as for many other types of bone conductors, be a traditional electromagnetic vibrator, a balanced electromagnetic vibrator or for example a piezoelectric vibrator. In the present invention, the vibrator is integrated in one unit and in this way the vibrator can be made very efficient. A piezoelectric vibrator is an integrated vibrator type because for a piezoelectric vibrator the transformation of the electrical signal into a mechanical vibration force or a mechanical vibration displacement occurs in the material itself. An electromagnetic vibrator could however be made either integrated or nonintegrated.

For an electromagnetic vibrator that is integrated in one unit the transformation of the electric signal into a mechanical vibration force or a mechanical vibration displacement occurs in the integrated vibrator. The mechanical vibrations are generated by the electromagnetic signal field in the air gap of the vibrator. This air gap may of course be filled with for example a fluid or gel to improve the performance. A narrow air gap gives less leakage of the magnetic field and gives therefore a high efficiency of the vibrator.

For a nonintegrated electromagnetic vibrator, the electromagnetic signal field is transmitted from one part of the vibrator, that is located in one unit, over to another part of the vibrator, located in another unit, so that the mechanical vibrations are generated from the electromagnetic signal field between the two units of the nonintegrated vibrator. For a nonintegrated vibrator, the two units of the vibrator are separated and not mechanically connected to each other with for example spring arrangements.

For a nonintegrated vibrator used for a bone conduction hearing aid, the two units of the vibrator are often separated by the patient's skin so that the electromagnetic signal field passes trough the skin.

In the present invention, the electromagnetic signal does not pass through the skin.

In the present invention, the mechanical vibrations from the integrated vibrator pass through the skin on its way from the vibrator to the implanted unit.

In a preferred embodiment, the hearing aid system of the present invention has an implanted unit that has a magnetic portion so that the external hearing aid unit can be magnetically attached to the implanted unit. The implanted unit has a fixation portion so that it can be anchored in the skull bone. The implanted unit is fully implanted under the skin so there is no permanent skin penetration from where it is possible to reach the implanted unit.

The vibrator of the present invention is preferably an electromagnetic vibrator with a closed magnetic signal field. Typical for a closed magnetic field is that it always goes around in some sort of loop. The closed loop of the magnetic signal field is substantially inside the vibrator that is inside of the external hearing aid unit.

To have a sufficient pressure distributing surface against the skin, the area of the skin contact surface of the skin contact pressure plate of the present invention should be at least 80 mm². The skin contact plate may have any shape. It may for example be round, oval or square shaped. In a preferred embodiment the skin contact pressure plate has a permanent magnet and the magnetic portion of the implanted unit consists of a ferromagnetic material. The advantage of this arrangement is that there is no permanent magnet implanted in the patient. The magnet of the skin contact pressure plate may be arranged so that it forms either a closed magnetic field or an open magnetic field. The advantage with a closed magnetic field is that the main part of the magnetic field is in the gap between the skin contact pressure plate and the magnetic portion of the implanted unit. However, considering that the skin is quite thick and the diameter of the skin contact pressure plate is limited it may be difficult to design an efficient magnetic attachment that has a closed magnetic field. It may then be better to have a solution with an open magnetic field instead. In an alternative embodiment, both the skin contact pressure plate and the magnetic portion of the implanted unit may include permanent magnets. In a preferred embodiment, the magnetic portion of the implanted unit has a permanent magnet and the skin contact pressure plate consists of a ferromagnetic material. The advantage with this solution is that the external hearing aid unit does not have any permanent magnets, which means it is not attracted to ferromagnetic material when it is for example placed in a drawer when it is not used.

In a preferred embodiment, the magnetic portion and the fixation portion of the implanted unit are two separate components. The fixation portion is used to fixate the magnetic portion to the skull bone. The advantage with this is that the magnetic portion may for example be replaced or removed in a quite simple surgical procedure without removing the fixation portion that is anchored in the skull bone. In this embodiment there is a connection between the fixation portion and the magnetic portion. The connection between the fixation portion that is anchored in the skull bone and the magnetic portion of the implanted unit may include a connection screw that can go through a hole in the implanted unit and into a threaded hole inside the fixation portion to allow the magnetic portion to be mounted on the fixation portion. The fixation portion is preferably designed as a screw shaped titanium implant.

In the present invention, there is some damping of the vibrations when the vibrations pass through the skin. In a preferred embodiment of the present invention, the external hearing aid unit has a digital feedback suppression circuit. The feedback suppression circuit reduces the output of the vibrator at those frequencies where feedback is most likely to occur and it is then possible to have an overall higher gain in the present invention. The feedback suppression circuit is usually part of the amplifier circuitry or may be separate and may then be called a feedback cancellation circuit. To minimize the risk for acoustic feedback a preferred embodiment of the present invention includes a vibrator suspension between the vibrator and the housing of the external hearing aid unit. This vibrator suspension reduces the transfer of vibrations from the vibrator to the housing so that less of the output signal goes back into the microphone.

In a preferred embodiment of the present invention the average diameter of the skin contact pressure plate is at least 70% of the width of the vibrator. The vibrator takes up a significant portion of the space in the external hearing aid unit. It is an efficient design that is also good from an esthetic point of view, if the average diameter of the skin contact pressure plate is at least 70% of the width of the vibrator. The space between the external hearing aid housing and the skin should be sufficiently used to accommodate the skin contact pressure plate. The expression average diameter rather than the diameter is used here since the skin contact pressure plate may for example be oval or squared in its shape.

In a preferred embodiment of the present invention, the magnetic attraction force in lateral direction between the skin contact pressure plate and the implanted unit is at least 2 Newton when the skin contact pressure plate is at a distance of 5 mm from the implanted unit. The distance 5 mm may represent a skin thickness for some patients and the force of 2 Newton is required both to keep the external hearing aid unit in place and to allow an efficient transmission of the vibrations through the skin.

In a preferred embodiment of the present invention, the edge of the skin contact pressure plate that is facing the skin is a smooth edge. A smooth edge may mean an edge that is less sharp than a 90 degrees sharp edge. The edge may be rounded or it may be designed with for example a bevel. It is often important to avoid a sharp edge here since a sharp edge may cut into the skin and cause discomfort.

In a preferred embodiment of the present invention, the skin contact pressure plate has a coupling at a lateral side of the skin contact pressure plate. In that way the skin contact pressure plate may be easily changed and may be individually fitted for each patient in terms of for example magnet strength and size of the skin contact pressure plate.

In a preferred embodiment of the present invention, the skin contact pressure plate has a skin contact spacer at its contra lateral end and the skin contact spacer has a coupling to the skin contact pressure plate. This skin contact spacer serves to reduce the force of the magnetic attachment between the external hearing aid unit and the implanted unit.

For a patient with quite thick skin between the implanted unit and the skin contact pressure plate, no skin contact spacer might be needed. However, for a patient with quite thin skin in this area, a skin contact spacer might be useful to reduce the magnetic attachment force. The skin contact spacer may be of plastic and may increase the distance between the magnetic portion of the skin contact pressure plate and the skin of the patient.

In a more powerful version of the present invention, the external hearing aid unit may be designed with a head worn part with the vibrator and the skin contact pressure plate and then a cord that goes to a body worn part where the amplifier, battery and microphone are located.

The external hearing aid unit may use all kinds of available hearing technology and electronics to achieve the optimal performance. The microphone may be a directional microphone or two or more microphones connected to an electronic directionality processor.

The magnetic portion of the implanted unit may be positioned on the surface of the skull bone or it may be positioned more into the skull bone. A cavity may for example be drilled out in the bone so that the magnetic portion could be placed a bit deeper in the skull bone so that it does not stick out so much in lateral direction from the surface of the skull bone.

### BRIEF DESCRIPTION OF THE DRAWINGS

FIG. 1 is a cross-sectional side view of the hearing aid system of the present invention;

FIG. 2 is a cross-sectional top view of the hearing aid system of the present invention; and

FIG. 3 is a cross-sectional top view of the hearing aid system shown in FIG. 2.

### DETAILED DESCRIPTION

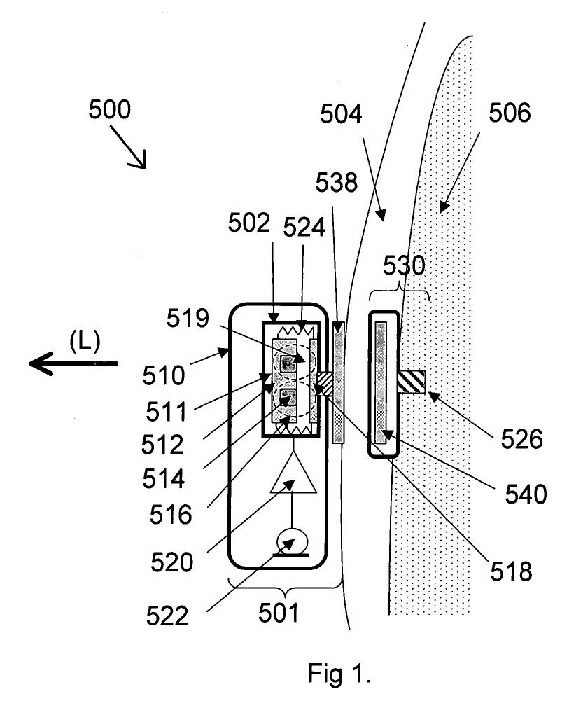

FIG. 1 is a cross-sectional side-view of the hearing aid system 500 of the present invention. An external hearing aid unit 501 has a vibrator 502 disposed therein. The vibrator 502 may be an assembled integrated unit so that all vibrator components may be disposed inside the external hearing aid unit 501. Preferably, the vibrator 502 has a vibrator plate 518 that is connected to a skin contact pressure plate 538 via a connector segment. The skin contact pressure plate 538 is magnetic so that it is magnetically attracted to a magnetic portion 540 of an implanted unit 530 that is anchored in the skull bone 506 by a fixation portion 526. This magnetic interaction presses the skin contact pressure plate 538 against the skin 504. The vibrations from the integrated vibrator 502 are transmitted to the skin contact pressure plate 538 and then through the skin 504 of the skull bone 506 to the implanted unit 530. It is also possible to make the skin contact pressure plate 538 of a suitable material that is not magnetic such as a metal that is magnetically attracted to the magnetic portion 540 of the implanted unit 530. Of course, it is also possible to make the portion 540 of a suitable material that is magnetically attracted to the magnet of the skin contact pressure plate 538. The important feature of the present invention is that there is a magnetic attachment between the skin contact pressure plate 538 and the implanted unit 530. It is not necessary that both the skin contact pressure plate 538 and the implanted unit 530 must have a permanent magnet.

The vibrator 502 may be an integrated electromagnetic vibrator that has a magnetic generating component 511 that comprise a bobbin 512 and a coil 514. The coil 514 generates an alternating magnetic field 516 that is marked with a dotted line in FIG. 1. The alternating magnetic field 516 goes through the bobbin 512 and over to the vibrator plate 518 via an air gap 519. The vibrator plate 518 oscillates in relation to the bobbin 512. An amplifier 520 amplifies the electrical signal from a microphone 522 before the electric signal goes into the coil 514. The bobbin 512 is suspended in the vibrator plate 518 with a suspension 524 so that the air gap 519 does not collapse. The external hearing aid unit 501 has a housing 510. The arrow (L) indicates the lateral direction.

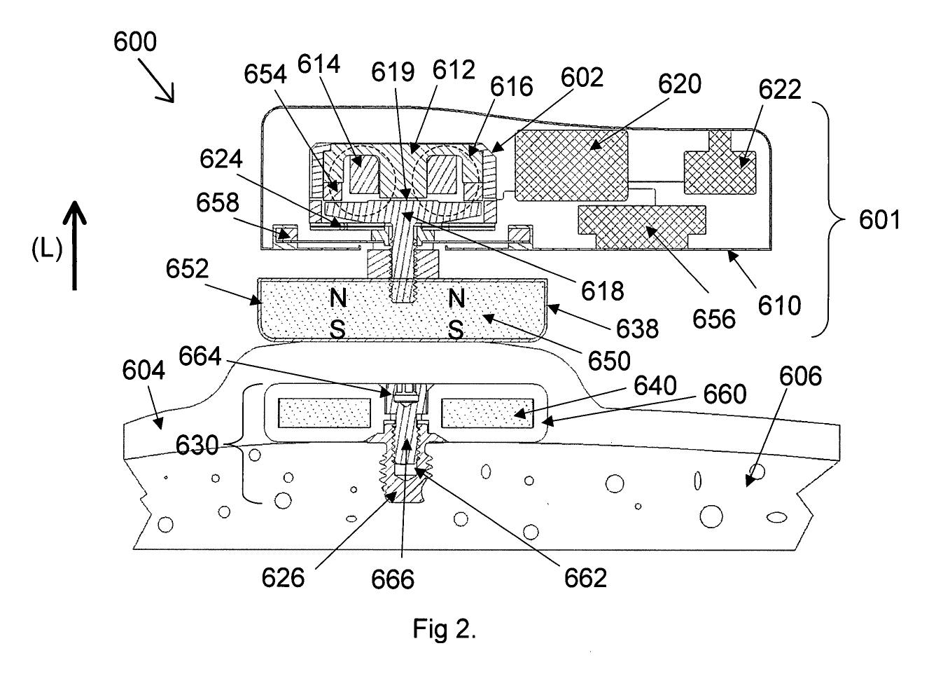

FIG. 2 is a cross-sectional view of a hearing aid system 600 of the present invention 600. An external hearing aid unit 601 has a vibrator 602. The vibrator 602 is an assembled integrated unit. The vibrator 602 has a vibrator plate 618 that is connected to a skin contact pressure plate 638. The skin contact pressure plate 638 has a magnetic portion 650 disposed inside a surface material 652. The skin contact pressure plate 638 is therefore magnetic so that the plate 638 is magnetically attracted to a magnetic portion 640 of an implanted unit 630 that is anchored in the skull bone 606 by a fixation portion 626. This magnetic interaction presses the skin contact pressure plate 638 against the skin 604. The vibrations from the integrated vibrator 602 are transmitted to the skin contact pressure plate 638 and then through the skin 604 of the skull bone 606 to the implanted unit 630 that is anchored in the skull bone 606.

The vibrator 602 may be an integrated electromagnetic vibrator with a bobbin 612 and a coil 614. The coil generates an alternating magnetic field 616 that is marked with a dotted line. The alternating magnetic field 616 goes through the bobbin 612 and over to the vibrator plate 618 via an air gap 619. The vibrator plate 618 oscillates in relation to the bobbin 612. The vibrator 602 has also a permanent magnet 654 that generates a static magnetic field that in this embodiment follows the same path as the alternating magnetic field 616. An amplifier 620 amplifies the electrical signal from a microphone 622 before the electric signal goes into the coil 614. The amplifier 620 and the microphone 622 may be powered by a battery 656. Preferably, the bobbin 612 is suspended in the vibrator plate 618 with a suspension 624 so that the air gap 619 does not collapse. The external hearing aid unit 601 has a housing 610. The vibrator 602 is suspended in the housing 610 with a suspension 658 to reduce the transfer of vibrations from the vibrator 602 to the housing 610.

The magnetic portion 640 of the implanted unit 630 is enclosed by a cover 660. The fixation portion 626 has a threaded inner hole 662. The cover 660 has a mounting hole 664. A connection screw 666 goes through the mounting hole 664 and into the threaded inner hole 662 to connect the magnetic portion 640 to the fixation portion 626. The arrow (L) indicates the lateral direction.

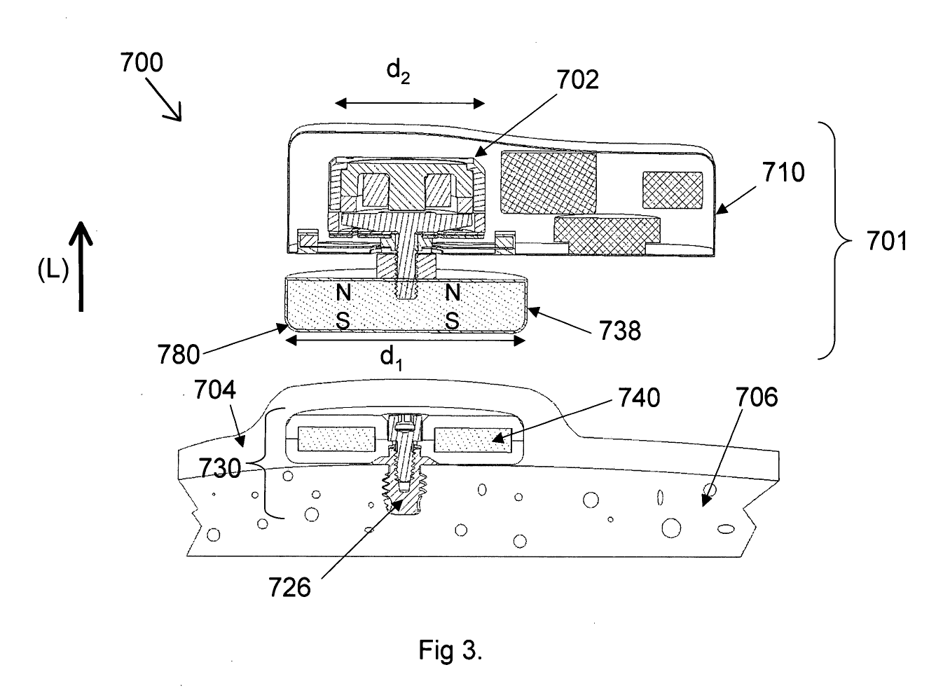

FIG. 3 is a cross-sectional view of the same embodiment as in FIG. 2. However, in FIG. 3 an external hearing aid unit 701 is shown in a position where the unit 701 has been moved away from the skin 704. The external hearing aid unit 701 has a housing 710 and a vibrator 702 that may be assembled as an integrated unit. The external hearing aid unit 701 has a skin contact plate 738 that is magnetic. An implanted unit 730 has a magnetic portion 740 and a fixation portion 726 that is anchored in a skull bone 706. The arrow (L) indicates the lateral direction. The distance (d₁) represents the diameter of the skin contact pressure plate. The distance (d₂) represents the width of the vibrator 702. The edge 780 on the skin contact pressure plate that is facing the skin is rounded to present a smooth edge against the skin 704. In this way the hearing aid unit 701 may easily be removed from the skin 704 by overcoming the magnetic attraction forces between the magnet of the skin contact plate 738 and the magnetic portion 740 of the implanted unit 730. The unit 701 may also easily be re-attached by moving the contact plate 738 close to the implanted unit 730 so that the magnetic forces pull the unit 701 against the skin 704 to hold the unit 701 in place against the skin 704.

For all of the above embodiments several alternative designs and combinations are possible and the invention is not limited to the preferred embodiments presented above. While the present invention has been described in accordance with preferred compositions and embodiments, it is to be understood that certain substitutions and alterations may be made thereto without departing from the spirit and scope of the following claims.

1. A hearing aid system for generating bone conduction vibrations, comprising:
an external hearing aid unit;
the external hearing aid unit having a vibrator and a skin contact pressure plate;
the skin contact pressure plate being placed on an outside of the external hearing aid unit;
the skin contact pressure plate being in magnetic operative engagement with and in non-contact with an implanted unit;
the implanted unit being anchored in a skull and disposed under a skin of the skull, the implanted unit being entirely covered by the skin;
the external hearing aid unit having a housing;
the vibrator is integrated so that all vibrator components are disposed in the external hearing aid unit;
the vibrator having transformation means for transforming an electrical signal into mechanical vibrations; and
the skin contact pressure plate being in operative engagement with the vibrator, the skin contact pressure plate having transmission means for transmitting vibrations from the vibrator to the implanted unit when the skin contact pressure plate is being magnetically attached to the implanted unit.

2. The hearing aid system according to claim 1 wherein the hearing aid system has an implanted unit that has a magnetic portion so that the external hearing aid unit is magnetically attached and the implanted unit has a fixation portion for anchoring in a skull bone.

3. The hearing aid system according to claim 1 wherein the vibrator is an electromagnetic vibrator that has a closed electromagnetic signal field and a closed loop of the closed electromagnetic signal field is substantially inside the external hearing aid unit.

4. The hearing aid system according to claim 1 wherein an area of a skin contact surface of the skin contact pressure plate is at least 80 mm².

5. The hearing aid system according to claim 1 wherein the skin contact pressure plate has a permanent magnet.

6. The hearing aid system according to claim 1 wherein a magnetic portion of the implanted unit consists of a ferromagnetic material.

7. The hearing aid system according to claim 1 wherein both the skin contact pressure plate and a magnetic portion of the implanted unit have permanent magnets.

8. The hearing aid system according to claim 1 wherein a magnetic portion of the implanted unit has a permanent magnet and the skin contact pressure plate consists of a ferromagnetic material.

9. The hearing aid system according to claim 1 wherein a magnetic portion and a fixation portion of the implanted unit are two separate components and there is a connection between the fixation portion and the magnetic portion.

10. The hearing aid system according to claim 9 wherein the hearing aid system has a connection screw that extends through a hole in the magnetic portion of the implanted unit and into a threaded hole inside the fixation portion to allow the magnetic portion to be mounted on the fixation portion.

11. The hearing aid system according to claim 1 wherein the hearing aid system has a digital feedback suppression circuit in the external hearing aid unit.

12. The hearing aid system according to claim 1 wherein the hearing aid system has a vibrator suspension between the vibrator and the housing.

13. The hearing aid system according to claim 1 wherein an average diameter of the skin contact pressure plate is at least 70% of a width of the vibrator.

14. The hearing aid system according to claim 2 wherein a magnetic attraction force in a lateral direction between the skin contact pressure plate and the implanted unit is at least two Newton when a distance between the skin contact pressure plate and the implanted unit is 5 mm.

15. The hearing aid system according to claim 1 wherein an edge of the skin contact pressure plate facing the skin is smooth.

16. The hearing aid system according to claim 1 wherein the skin contact pressure plate has a coupling at a lateral side of the skin contact pressure plate.

17. The hearing aid system according to claim 1 wherein the skin contact pressure plate has a skin contact spacer at a contra lateral end of the skin contact pressure plate, the skin contact spacer having a coupling to the skin contact pressure plate.

18. A method of conducting vibrations from a vibrator to the skull bone, comprising:
providing an external hearing aid unit having an integrated vibrator and a skin contact pressure plate;
magnetically attracting the skin contact pressure plate to an implanted unit disposed under a skin of a skull bone;
transmitting vibrations from the vibrator to the skin contact pressure plate; and
transmitting the vibrations from the skin contact pressure plate through the skin and to the implanted unit and the skull bone.
